(19) United States
(12) Patent Application Publication
(10) Pub. No.: US 2008/0283701 A1
(43) Pub. Date: Nov. 20, 2008

(54) TOOL HOLDER

(76) Inventor: Peter Kahn, Brookhaven, NY (US)

Correspondence Address: ADVANTIA LAW GROUP, 9035 SOUTH 1300 EAST, SUITE 200, SANDY, UT, 84094, US

(21) Appl. No.: 12/044,750

(22) Filed: Mar. 7, 2008

Related U.S. Application Data
(60) Provisional application No. 60/893,938, filed on Mar. 9, 2007.

(51) Int. Cl. B44D 3/00

(52) U.S. Cl. 248/213.2; 248/309.1

(57) ABSTRACT

A tool holder device for holding a tool. A tool holder comprises of a clip member, wherein the clip includes a first clamping and a second clamping member, both having jaws and handles. A biased pivot couples the first clamping member and the second clamping member together. The first jaw and the second jaw interconnect. The first jaw and the second jaw may also include ridges. A plurality of coupling members may be permanently disposed about the surfaces of the first and/or the second clamping member. The clip may also include an attachment tool, wherein the tool includes a paint container member and a punctioner member. The first clamping member may include an upper portion and a lower portion. The upper portion of the first clamping member may be actuable through an angle. The first clamping member may be one continuous member.

### CROSS-REFERENCE TO RELATED APPLICATIONS

This invention claims priority, under 35 U.S.C. § 120, to the U.S. Provisional Patent Application No. 60/893,938 to Kahn filed on Mar. 9, 2007, which is incorporated by reference herein.

### BACKGROUND OF THE INVENTION

1. Field of the Invention

The present invention relates to a tool holder, specifically an adjustable tool holder.

2. Description of the Related Art

Professional painters generally use a brush and/or a roller to apply paint to desired surfaces. Painters must be efficient throughout their professional work in order to maintain competitive prices. A long standing problem with most professional painters is alternating between different aspects of a paint job without spending unnecessary time to set up or take down the necessary equipment. Painters need to maintain their brushes and/or rollers in good and clean condition, as to avoid unnecessary time spent in clean up and/or removal of excess paint. Holders for tools and/or rollers have been devised, but they have limitations in applicability and effectiveness. Some improvements have been made in the field. Examples include but are not limited to the references described below, which references are incorporated by reference herein:

U.S. Pat. No. 3,756,550, issued to Kollitz, discloses a spring clip device having a main body and a spring-biased, pivotal body member held in a close relationship with each other by a spring means which is forcibly engaged against a bail integrally formed to the main body, the forward end of both bodies being in biased contact with each other, the opposite, free ends thereof being spaced apart to provide for a pivotal movement of the bodies about a fulcrum point located substantially below the spring means.

U.S. Pat. No. 2,931,086, issued to Rose, discloses a clothes pin or similar clamps consisting of two beams of synthetic resin connected at their central sections. Clothes pin have for example been manufactured consisting of two cast beams connected with each other by means of a coil spring the ends of which clasp the outer surface of the beams similarly as is known from ordinary clothes pin of wood.

U.S. Pat. No. 6,971,147, issued to Halstead, discloses a clip for holding banknotes that has a first clasp portion and a second clasp portion for holding banknotes there between. The first clasp portion has a first magnetic portion including magnetic material and the second clasp portion has a second magnetic portion including magnetic material. The first magnetic portion is moveable relative to the second magnetic portion between: a closed position whereby the interaction of the magnetic material of the first magnetic portion and second magnetic portion is such that there is a net force of attraction to hold the first and second clasp portions together; and an open position whereby the first and second clasp portions are released apart.

U.S. Pat. No. 5,179,768, issued to Jio, discloses a clothespin made of plastic as one unit, having two opposite pin plates, an elastic bridge formed between intermediate portions of the pin plates, an elastic plate respectively extending from a bottom end of each pin plate and bending inward, one elastic plates having a bending stopper formed at the end and two projections extending up and under near the end stopper, the elastic plate with the stopper being pressed upward to let the top of the other elastic plate push and support the former elastic plate so as to keep both of them in that position and to be compressed by the lower portions of the pin plates to open the upper portions for pinching clothes between them.

U.S. Pat. No. 3,085,777, issued to Etal, discloses a clipboard for holding flat items, such as an individual pieces of paper or a tablet, and for providing a backing for such an item, and deals more particularly with a clipboard including magnetic means for holding the clipboard to various magnetic surfaces.

U.S. Pat. No. 3,597,813, issued to Takahashi, discloses a clamping device comprising a pair of clamping members pivotally fixed to each other, one of said clamping members having an elongated opening through which extends a clamping spring and an arcuately curved leading end portion while the other clamping member has the arcuate compression spring for clamping which extends through said opening and presses against said curved portion the center of the radius of curvature of which is slightly deviated from the pivotal point of said pair of clamping members.

U.S. Pat. No. 6,085,393, issued to Tsui et al., discloses a badge strap attachment that includes a clothing attachment member for attaching to clothing of a user. A badge coupling member is secured to the clothing attachment member. The badge coupling member is capable of forming a closed loop for coupling to a badge through a slot in the badge. A secondary mounting fixture on the badge coupling member enables a supplemental display surface to be mounted to the badge coupling member above the badge and simultaneously displayed.

U.S. Pat. No. 6,929,225, issued to Kent, discloses a tool clip that is for attaching a tool to a bucket without obstructing access to paint. The clip includes a body with flat central portion, including magnet and ferromagnetic housing. First prong and second prong are attached to body. Clip mounts on upper rim of a bucket with body in interior space of bucket, retained by compression of prongs on outer surface of bucket. Ferrule of brush is removably attached to ferromagnetic housing and prevented from slipping by ridges. Handle aids in removing clip from bucket.

U.S. Pat. No. 5,033,704, issued to Kerr, discloses a monolithic one-piece body that is releasably attached to a groove surrounding an open mouth of a paint container and has a top shelf that extends over that open mouth. A magnet is located in the top shelf and magnetically affixes a tool bristle ring to the top shelf in a manner which locates the tool bristles over the paint container open mouth. The top shelf can be parallel to a plane containing the open mouth, or can be tilted, and various magnet elements are used and are spaced at various locations to accommodate plural brushes or to locate brushes at various locations on the top shelf.

U.S. Pat. No. 4,101,046, issued to Puntillo, discloses a tool holder that is provided with a base having a lip which is complemental to the chime of a paint can and includes a cradle having a flat edge at its juncture with the base and offstanding at an acute angle with respect to the base, a brush retention means associated with an upper extremity of the cradle to support a tool by the metal band thereon, the flat edge of the cradle at the juncture of cradle and base providing for wiping excess paint from a brush dipped in the paint can.

U.S. Pat. No. 5,083,733, issued to Marino et al., discloses a clamp clamping a side of a container that has a head portion and a pair of leg portions extending from the head portion and partially abutting opposite surfaces of the side of the container when in use. The head portion has support part angularly inclined to the leg portions. A first permanent magnet is mounted on the support part of the head portion in a manner whereby the magnet releasably holds a brush via the magnetic metal part of the brush over the lip of the container with the bristles of the brush over the open container and sloped downward from the handle of the brush, so that liquid on the bristles will drip into the container without befouling any of the brush, the container, or the proximate area of the container. A second permanent magnet is mounted on one of the leg portions of the clamp in a manner whereby the second magnet magnetically couples the clamp to a magnetic metal container.

The inventions heretofore known suffer from a number of disadvantages which include being inconvenient, being cumbersome, being limited in application, being limited in versatility, failing to facilitate opening paint and/or spackle containers, being expensive, being difficult to use, being heavy, being easily breakable, and/or being unduly complex.

What is needed is a tool holder that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available tool holders. Accordingly, the present invention has been developed to provide an efficient and reliable device to secure and store a tool.

A tool holder device for holding a tool that may comprise of a clip member. The clip member may include a first clamping member that may have a first jaw and a first handle. The first handle and the first jaw may be coupled together. A second clamping member may be coupled to the first clamping member. The second clamping member may have a second jaw and a second handle. The second handle may be coupled to the second jaw. A biased pivot may be disposed between the first clamping member and the second clamping member. The biased pivot may be configured to pivotally couple the first clamping member and the second clamping member. The biased pivot may include an open mode and a closed mode. In addition in the closed mode, the first jaw and the second jaw may interconnect. A plurality of coupling members may be permanently disposed about a surface of the first clamping member and/or the second clamping member.

The first clamping member may be actuable through an angle. The actuation may enable a user to adjust the angle of the first clamping member to conveniently dispose a tool about a container. The first jaw and the second jaw may include ridges that may be configured to secure the clip member about a container. The biased pivot may be selected from the group consisting of: a push button locking mechanism, a spring type locking mechanism, or a combination thereof. The first handle may include an upper portion and a lower portion. The upper portion of the first handle may be actuable through an angle. The lower portion may enable the biased pivot to actuate between the open mode and the closed mode.

The first clamping member and the second clamping member may each comprise rubber. Furthermore, a thin hard/flexible material may be disposed in the rubber. In addition, a protective covering may be disposed about the rubber, wherein the rubber may enable the user to manipulate either the first and/or second clamping member to a desired configuration to secure and support the tool. Moreover, the first clamping member may be one continuous member.

The tool holder may also include an attachment tool, wherein the attachment tool may be selectably coupled to the second handle of the second clamping member of the tool holder. The attachment tool may include a paint container member and a punctioner member coupled together by a securing member. The paint container member may comprise a rounded metal, designed to fit in between a paint container lid and a paint container rim. Furthermore, the rounded metal may be beveled in configuration. The paint container member may be disposed on the opposite end of the securing member relative to the punctioner member. The punctioner member may comprise a metal member shaped to a point, designed to fit in the paint container rim. In addition, the metal member may be shaped to a point, which also may be beveled. The securing member may be comprised of a firm plastic composite that may be grooved and/or include ridges. The securing member may be configured to resemble the first handle of the first clamping member of the tool holder.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 illustrates a side perspective view of a tool holder, according to one embodiment of the invention;

FIG. 2 illustrates a back perspective view of a tool holder, according to one embodiment of the invention;

FIG. 3 illustrates a side perspective view of a tool holder, according to one embodiment of the invention;

FIG. 4 illustrates a side cross sectional view of a top member of a tool holder, according to one embodiment of the invention;

FIG. 5 illustrates a side perspective view of a tool holder, according to one embodiment of the invention;

FIG. 6 illustrates a side perspective view of a tool holder, according to one embodiment of the invention; and

FIG. 7 illustrates a perspective view of a tool holder engaging a paint container, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

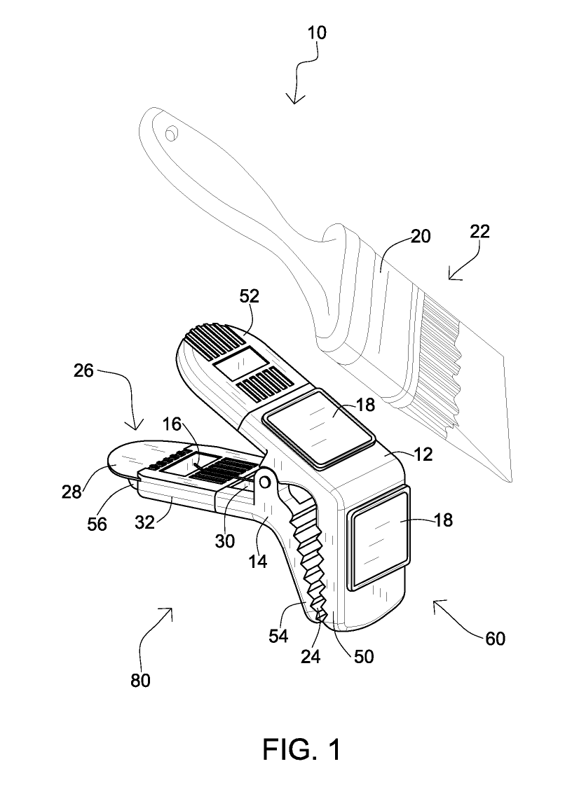

FIG. 1 illustrates a tool holder 10, according to one embodiment of the invention, wherein the tool holder 10 includes a clip member 80. The clip member 80 includes a first clamping member 12 and a second clamping member 14 pivotally coupled together by a spring-type mechanism 16. One non-limiting example of a spring-type mechanism is described in U.S. Pat. No. 5,979,019, issued to Johnson which is incorporated by reference herein. The first clamping member 12 includes a first jaw 50 and a first handle 52. In addition, the second clamping member 14 also includes a second jaw 54 and a second handle 56. The clamping members 12, 14 firmly couples to a rim of a paint and/or spackle container in a substantially vertical position. FIG. 1 further illustrates a coupling member 18 coupled to the first clamping member 12, wherein the coupling member 18 is configured to selectably couple to the ferrule 20 of a tool 22, thereby holding the tool 22 firmly and securely in place. The first and second clamping members 12, 14 also include ridges 24 configured to firmly and securely couple the tool holder 10 to the rim of a paint and/or spackle container. In order to avoid slippage of the tool 22 while set on the holder 10, and to avoid spillage of any paint onto unwanted areas and/or surfaces.

FIG. 1 further illustrates an attachment tool 26 selectably coupled to the second clamping member 14 of the tool holder 10. The attachment tool 26 includes a paint container member 28 and a punctioner member 30 coupled together by a securing member 32. The paint container member 28 comprises a rounded metal member, designed to fit in between a paint container lid and a paint container rim. Furthermore, the rounded metal member may be beveled in configuration. The paint container member 28 is disposed on the opposite end of the securing member 32 relative to the punctioner member 30. The punctioner member 30 comprises a sharp metal member shaped to a point, designed to fit in the rim of the paint and/or spackle container. In addition, the punctioner member 30 is shaped to a point, which also may be beveled. The securing member 32 comprises of a firm plastic composite that may be grooved and/or includes ridges. The securing member 32 is configured to resemble the first handle 50 of the first clamping member 12 of the tool holder 10.

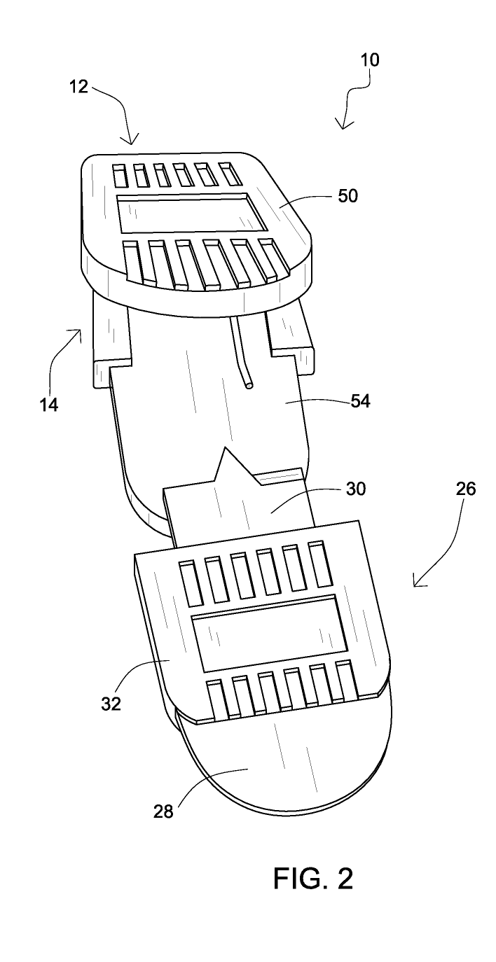

FIG. 2 illustrates an attachment tool 26 of a tool holder 10, according to one embodiment of the invention. The attachment tool 26 includes a paint container member 28 and a punctioner member 30 coupled together by a securing member 32. The paint container member 28 comprises a rounded metal member, designed to fit in between a paint container lid and a paint container rim. Furthermore, the rounded metal member may be beveled. The paint container member 28 is disposed on the opposite end of the securing member 32 relative to the punctioner member 30. The punctioner member 30 comprises a sharp metal member shaped to a point, designed to fit in the rim of the paint container. In addition, the punctioner member is shaped to a point, which also may be beveled. The securing member 32 comprises of a firm plastic composite that may be grooved and/or includes ridges. The securing member 32 is configured to resemble the first handle 50 of the first clamping member 12 of the tool holder 10.

FIG. 2 further illustrates a second clamping member 14 of a tool holder 10 configured to receive and support the attachment tool 26. The second clamping member 14 is configured to receive the punctioner member 30. The attachment tool 26 is coupled to the tool holder 10 about the second handle 54 of the second clamping member 14. The second clamping member 14 couples to the securing member 32 about an aperture through the securing member 32, thereby displacing the punctioner member of the attachment tool 26.

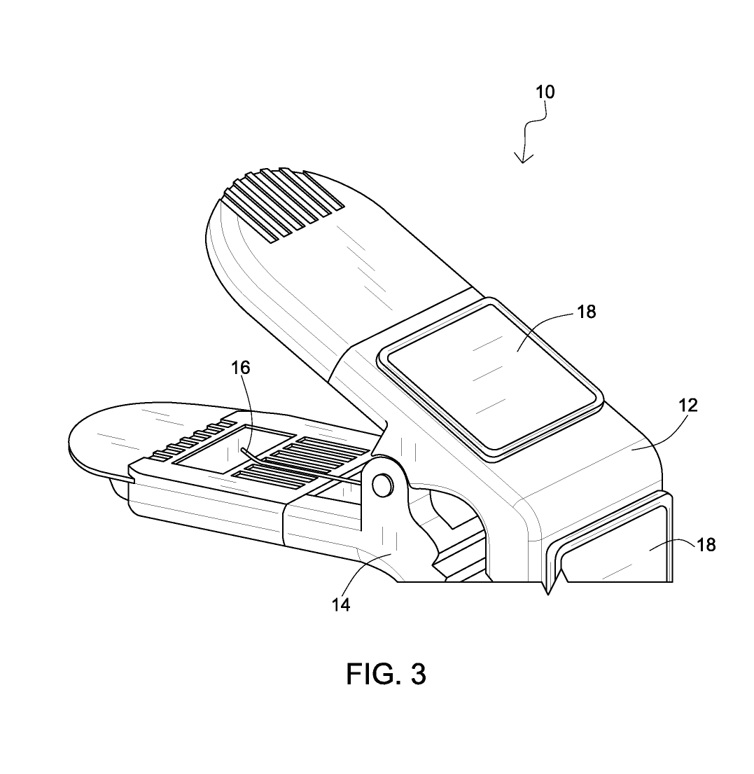

FIG. 3 illustrates a tool holder 10, according to one embodiment of the invention, wherein the holder 10 includes a first and a second clamping member 12, 14. The first and second clamping members 12, 14 are pivotally coupled together by a spring-type mechanism 16. The clamping members 12, 14 firmly couples to a rim of a paint and/or spackle container in a substantially vertical position. FIG. 3 further illustrates a coupling member 18 coupled to the first clamping member 12, wherein the coupling member 18 is configured to selectably couple to a tool, thereby holding the tool firmly and securely in place. As illustrated, the first clamping member 12 is configured in one uniform piece, wherein the first clamping member 12 may be manipulated to various angles and degrees

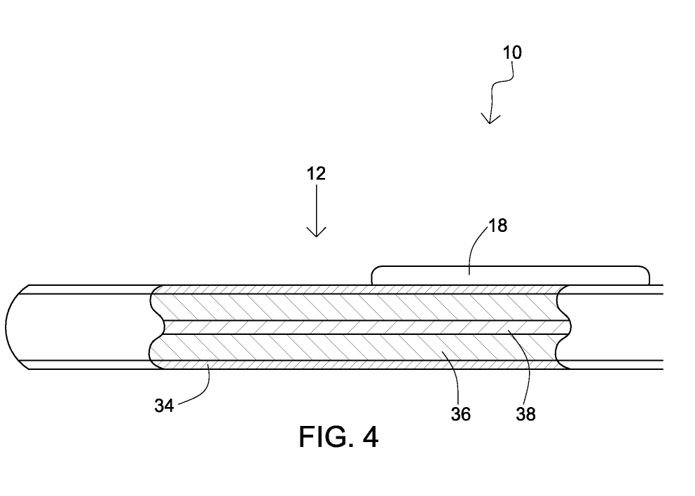

FIG. 4 illustrates a cross section of the tool holder as illustrated in FIG. 3, wherein the first clamping member 12 of the tool holder 10, wherein the first clamping member 12 includes a protective layer 34. The protective layer 34 is configured to cover the first clamping member 12, and also to protect the interior of the first clamping member 12. The interior of the first clamping member 12 includes a rubber composite 36, wherein the rubber composite 36 is configured to be manipulated and hold a particular angle or degree relative to the tool. The interior of the first clamping member 12 also includes a metal plate 38, wherein the metal plate 38 may be constructed of a thin metal material that is durable and/or flexible. Furthermore, the user may manipulate the first clamping member 12 into a variety of forms and/or angles; for holding the tool firmly and securely in place.

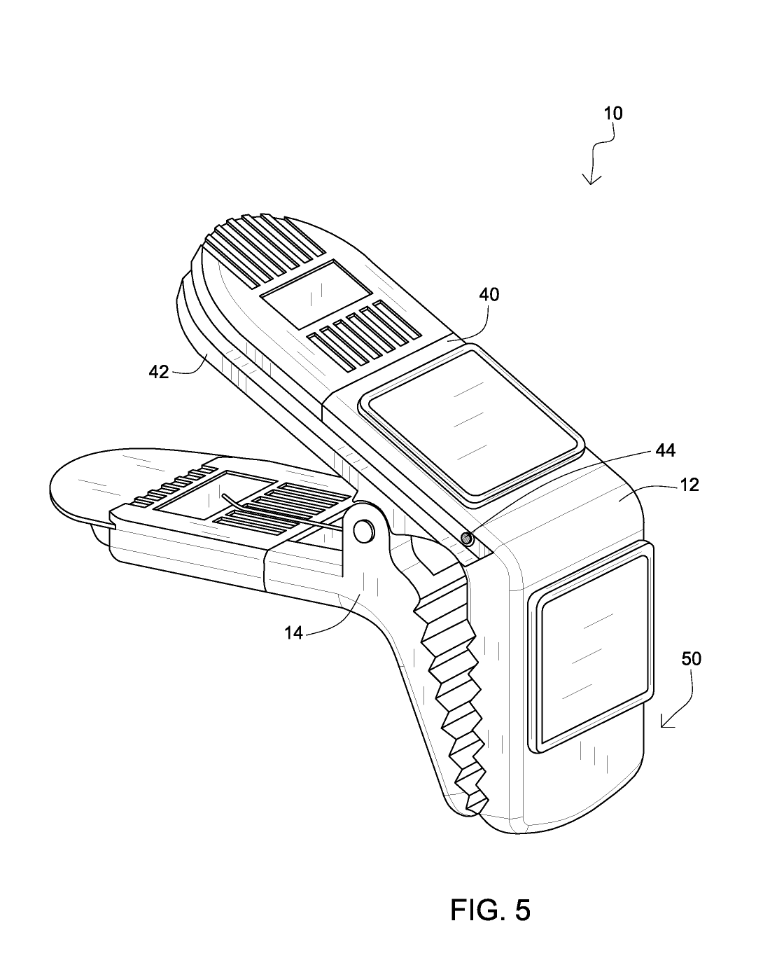

FIG. 5 illustrates another embodiment of a tool holder 10, wherein the tool holder 10 includes a first clamping member 12 having an upper and a lower portion 40, 42. The lower portion 42 of the first clamping member 12 is firmly coupled to the first jaw 50 of the first clamping member 12. The upper portion 40 of the first clamping member 12 is pivotally coupled to the first jaw 50 of the first clamping member 12 by a push-button locking mechanism 44; enabling a user to adjust the upper portion 40 of the first clamping member 12 into a variety of different angles; thereby holding the tool in either a vertical or a horizontal level. One non-limiting example of a push-button locking mechanism is described in U.S. Publication Application 2006/0016047, issued to Blackman et al., which is incorporated by reference herein. The upper and lower portions 40, 42 of the first clamping member 12 are separated by a gap. A level of degree of the angle between the upper and lower portion 40, 42 of the first clamping member 12 increases incrementally from 0 degrees to 90 degrees.

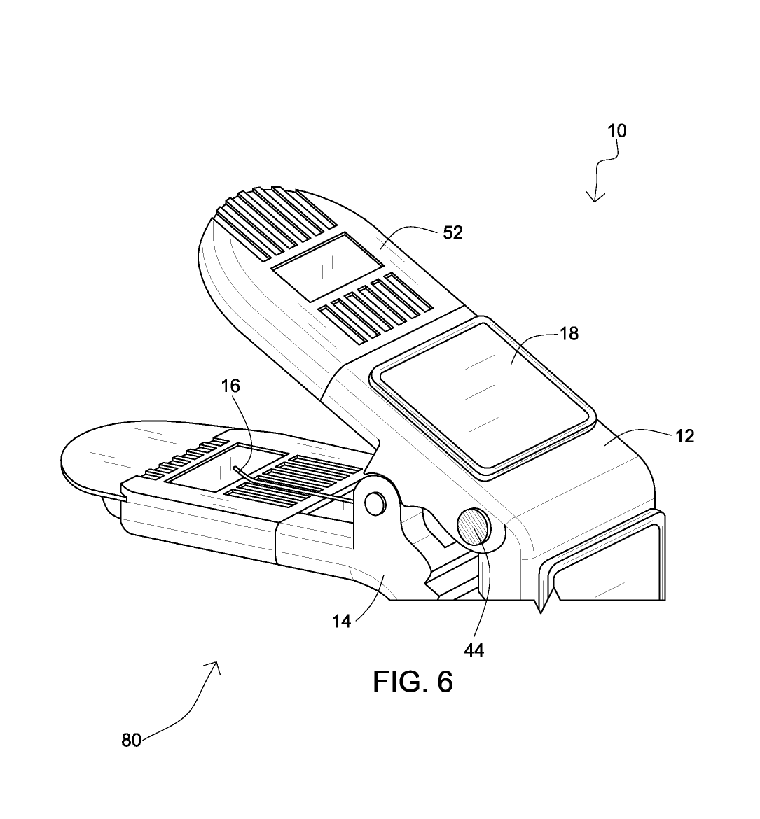

FIG. 6 illustrates a tool holder 10, according to one embodiment of the invention, wherein the holder 10 includes a first and second clamping member 12, 14. The first and second clamping members 12, 14 are coupled by a spring-type mechanism 16. Furthermore, this embodiment includes a push-button locking mechanism 44 enabling the user to adjust the angle of the first handle 52 of the first clamping member 12 when the clip member 80 is in a closed mode 60. A level of degree of the angle between the first and second clamping member 12, 14 increases incrementally from 0 degrees to about 90 degrees. One non-limiting example of a push-button locking mechanism is described in U.S. Publication Application 2006/0016047, issued to Blackman et al., which is incorporated by reference herein.

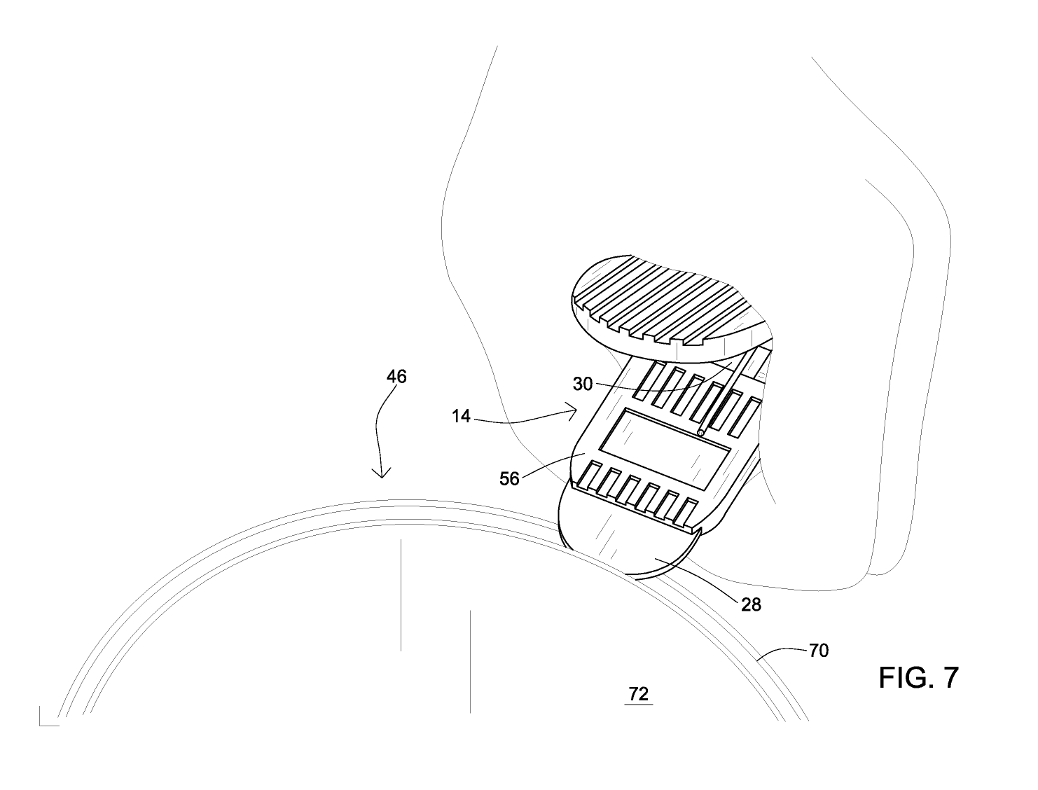

FIG. 7 illustrates an attachment tool about the second handle 56 of the second clamping member 14 of a tool holder 10. The second handle 56 of the second clamping member 14 is configured to receive and support the punctioner member 30 of the attachment tool. As illustrated, a user configures the paint container member 28 between a rim of a paint container 70 and a paint container lid 72, thereby opening the paint container 46.

In operation of one embodiment of the invention, the painter presses together the first and second handles of the first and second clamping member of the tool holder, thereby opening the jaws of the first and second clamping members of the tool holder into an open mode. The user then couples the tool holder along the rim of any 1 quart, 5 quarts, 1 gallon, or 5 gallon paint and/or spackle container and releases the first and second handles, thereby, firmly securing jaws of the first and second clamping members of the tool holder onto the rim of a paint and/or spackle container. The user then sets a tool, by ferrule, onto the magnet surface, thereby firmly and securely holding the tool in place.

In operation of another embodiment of the invention, after the user firmly and securely couples the tool holder along the rim of a paint and/or spackle container, the user then manipulates the upper portion of the first handle of the first clamping member of the tool holder into a variety of different angles as determined by the user to avoid spillage of paint and/or spackle and slippage of the tool while not in use.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate coupling members, one skilled in the art would appreciate that the coupling members may be but not limited to a magnet. Moreover, although the figures illustrate two magnets, one skilled in the art would appreciate that the device may comprise a number of magnets in different sizes, shapes, configuration, orientation, magnetic strength and number but still performing its intended function.

Additionally, although the figures illustrate a spring-type mechanism, one skilled in the art would appreciate that the device may be comprised of a variety of frictional coupling mechanisms, but still performing its intended function. For example, the frictional coupling mechanism may be such as, but not limited to: a pivot pin, pinch clamp, and/or spring clamp.

It is also envisioned that the present invention may be coupled to a variety of ledges, lips, ladder steps, extension pole, tool, and/or surface.

It is further envisioned that one skilled in the art would appreciate that the coupling member may be coupled to the second clamping member and still perform its intended function. In addition, the tool may be disposed about the first clamping member and still perform its intended function.

It is expected that there could be numerous variations of the design of this invention. For example the tool holder may vary in size, but still perform its intended function.

Finally, it is envisioned that the components of the device may be constructed of a variety of materials, such as but not limited to: plastic, metal, metal alloys, rubber composite, rubber, gel, glass, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A tool holder device configured to secure and support a tool, comprising:
a) a clip member, including:
a1) a first clamping member having a first jaw and a first handle;
a2) a second clamping member, coupled to the first clamping member, having a second jaw and a second handle;
a3) a biased pivot disposed between the first clamping member and the second clamping member, configured to pivotally couple the first clamping member and the second clamping member;
b) a coupling member permanently disposed about a surface of the first and/or the second clamping member; and
c) an attachment tool disposed about the second handle of the second clamping member, comprising:
c1) a paint container member, configured to open a paint container;
c2) a punctioner member, configured to punctioner materials; and
c3) a securing member disposed between the paint container member and the punctioner member, configured to secure the attachment tool to the second handle.

2. The device of claim 1, wherein the first clamping members is actuable through an angle.

3. The device of claim 1, wherein the coupling member comprising a magnet.

4. The device of claim 1, wherein the first jaw and the second jaw include ridges configured to secure the clip about a container.

5. The device of claim 1, wherein the biased pivot is selected from the group consisting of: a push button locking mechanism, a spring type locking mechanism, or a combination thereof.

6. The device of claim 1, wherein the first handle includes an upper portion and a lower portion, wherein the upper portion of the first handle is actuable through an angle and the lower portion enables the biased pivot to actuate.

7. The device of claim 1, wherein the first clamping member and the second clamping member each comprise rubber.

8. The device of claim 7, wherein the first clamping member and the second clamping member further comprise a thin hard/flexible material disposed in the rubber.

9. The device of claim 7, wherein the first clamping member and the second clamping member further comprise a protective covering disposed about the rubber.

10. The device of claim 1, wherein the first clamping member is one continuous member.

11. A tool holder device configured to secure and support a tool, consisting essentially of:
a) a clip member, including:
a1) a first clamping member having a first jaw and a first handle;
a2) a second clamping member, coupled to the first clamping member, having a second jaw and a second handle;
a3) a biased pivot disposed between the first clamping member and the second clamping member, configured to pivotally couple the first clamping member and the second clamping member;
b) a coupling member permanently disposed about a surface of the first and/or the second clamping member; and
c) an attachment tool disposed about the second handle of the second clamping member, comprising:
c1) a paint container member, configured to open a paint container;
c2) a punctioner member, configured to punctioner materials; and
c3) a securing member disposed between the paint container member and the punctioner member, configured to secure the attachment tool to the second handle.

12. The device of claim 11, wherein the first clamping members is actuable through an angle.

13. The device of claim 11, wherein the coupling member comprising a magnet.

14. The device of claim 11, wherein the first jaw and the second jaw include ridges configured to secure the clip about a container.

15. The device of claim 11, wherein the biased pivot is selected from the group consisting of: a push button locking mechanism, a spring type locking mechanism, or a combination thereof.

16. The device of claim 11, wherein the first handle includes an upper portion and a lower portion, wherein the upper portion of the first handle is actuable through an angle and the lower portion enables the biased pivot to actuate.

17. The device of claim 11, wherein the first clamping member and the second clamping member each comprise rubber.

18. The device of claim 17, wherein the first clamping member and the second clamping member further comprise a thin hard/flexible material disposed in the rubber.

19. The device of claim 17, wherein the first clamping member and the second clamping member further comprise a protective covering disposed about the rubber.

20. The device of claim 11, wherein the first clamping member is one continuous member.
